(19) United States
(12) Patent Application Publication
(10) Pub. No.: US 2010/0179273 A1
(43) Pub. Date: Jul. 15, 2010

(54) POWDER COATING COMPOSITIONS WITH CRYSTALLINE CONSTITUENTS THAT ARE STABLE IN STORAGE

(75) Inventors: Emmanouil Spyrou, Schermbeck (DE); Lars Hellkuhl, Gescher (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: EVONIK DEGUSSA GmbH, Essen (DE)

(21) Appl. No.: 12/090,255

(22) PCT Filed: Oct. 13, 2006
(86) PCT No.: PCT/EP06/67368

§ 371 Date: Jul. 3, 2008

(30) Foreign Application Priority Data
Oct. 17, 2005 (DE) 10 2005 049 916.3

(51) Int. Cl. C08L 75/04

(52) U.S. Cl. 524/507

(57) ABSTRACT

The present invention relates to storage-stable reactive powder coating compositions based on (semi)crystalline and amorphous ingredients and to their use as powder coatings.

The present invention relates to storage-stable reactive powder coating compositions based on (semi)crystalline and amorphous ingredients and to their use as powder coatings.

Reactive powder coating compositions are used intensively in the production of crosslinked coatings on a very wide variety of substrates. In comparison with thermoplastic compositions, reactive coating materials generally are harder, are more resistant to solvents and detergents, possess greater adhesion to metallic substrates, and do not soften when exposed to heightened temperatures.

For some time now reactive compositions in powder form have been known that are obtained, for example, by reacting a resin containing hydroxyl groups with an externally or internally blocked polyisocyanate. Powders of this kind are described in, for example, DE 27 35 497. These powders are used to coat ready-formed metal parts piece by piece (post-coated metal).

Radiation-crosslinkable powder coating materials are described in, for example, DE 101 63 826. The advantage of such systems lies in the separation of melting from curing, thereby generally allowing a smoother surface to be obtained. Additionally the temperatures are also lower than in the case of conventional powder coating materials, so that even temperature-sensitive materials, such as wood and plastic, can be coated.

The terms crystalline and semicrystalline are used synonymously in the text below. In both cases the polymers in question display a definite endothermic peak with an area of at least 1 J/g in the DSC.

Through the use of crystalline ingredients in the powder coating formulation it is possible to obtain a two-fold advantage. Firstly, the melt viscosity is lowered as a result, so that effective flow can be obtained even at relatively low temperatures. Secondly, the crystalline ingredients contribute to an increase in flexibility, which is necessary for certain applications, such as in coil coating. Examples of the use of crystalline ingredients are found not only in radiation-curing systems (DE 100 58 617) but also in thermosetting powder coating materials (DE 101 59 488).

U.S. Pat. No. 4,387,214 and U.S. Pat. No. 4,442,270 describe the use of (semi)crystalline polyesters made from terephthalic acid and hexane-1,6-diol in polyurethane powder coating materials as primers or topcoats for automobiles. These coating materials are very flexible. The surfaces, however, are decidedly soft and hence of low scratch resistance. High-gloss clearcoats cannot be produced with this powder coating material, since the crystalline polyester lacks compatibility with the amorphous isocyanate component. Clouding occurs in the coating film, and reduces the gloss. Nor can they be used in powder coil coating materials, since under the extreme curing conditions—curing at high temperatures with subsequent shock cooling—the films develop cracks.

U.S. Pat. No. 4,859,760 describes a powder coating composition comprising a mixture of amorphous and semicrystalline polyester polyols which are crosslinked using blocked polyisocyanates. The semicrystalline polyesters possess a glass transition temperature of −10 to +50° C. They contain terephthalic acid. Accordingly the weathering stability of the powder coatings is inadequate for demanding exterior applications such as automotive finishing or exterior architectural coating.

WO 94/02552 describes semicrystalline polyesters based on hexane-1,6-diol and 1,12-dodecanedioic acid as plasticizing agents for powder coating materials. The addition of the semicrystalline polyester enhances the leveling, the flexibility, and the deformability of the powder coating materials. When polyisocyanate crosslinkers containing uretdione groups are used, however, high proportions of (semi)crystalline polyester are needed in order to achieve the required flexibility, particularly for powder coil coating applications. As a result the gloss of the coatings is reduced. Moreover, the predominant dicarboxylic acid in the amorphous polyester is terephthalic acid. The consequence is a reduction in the weathering stability of the powder coatings.

WO 95/01407 describes thermosetting powder coating compositions comprising an amorphous polyester, made from cyclohexanedicarboxylic acid and a cycloaliphatic diol, a semicrystalline polyester, made from cyclohexanedicarboxylic acid and a linear diol, and a suitable crosslinker. These powder coatings are notable for high UV stability and very good flexibility. A disadvantage is the high price of the cyclohexanedicarboxylic acid ingredient.

It has been found that the use of (semi)crystalline polymers in powder coating materials, while enhancing leveling and flexibility, at the same time also gives rise to serious drawbacks: crystalline ingredients tend to lower the glass transition point of the powder coating formulation. As a result, the storage stability of the powder is reduced, and hence its sprayability.

It was an object of the present invention, therefore, to find powder coating compositions that are based on crystalline ingredients and are stable on storage for 28 days at elevated temperatures (35-40° C.), and hence can still be sprayed effectively after this time.

Surprisingly it has been found that by temporarily storing the powder coating compositions at a certain temperature (heat-treating them) it is possible to obtain a significant improvement in the storage stability of the final powder coating composition.

The invention accordingly provides storage-stable reactive powder coating compositions substantially containing
A) from 10% to 95% by weight of at least one amorphous component containing at least one reactive group
and
B) from 5% to 50% by weight of at least one (semi)crystalline component containing at least one reactive group,
C) if desired, from 3% to 30% by weight of at least one powder coating hardener,
D) if desired, auxiliaries and adjuvants,
the powder coating compositions being obtained by homogenizing components A) and B) and, where used, C) and/or D) in the melt and then storing (heat-treating) the composition for a certain time at more than 40° C. and less than the melting temperature of the (semi)crystalline component B).

As component A) use is made of amorphous polymers having a Tg of from 40 to 80° C. and containing reactive groups. These polymers may be polyesters, polyamines, polyamides, polycaprolactones, polyethers, polyurethanes, polyacrylates or mixtures or copolymers of the said polymers. Suitable reactive groups include free or blocked polyisocyanates, uretdiones, alcohols, amines, acids, hydroxyalkylamides, epoxides, oxazolines, carbodiimides, double bonds, CH-acidic groups, vinyl ethers, acrylates and/or methacrylates. Examples which can be used include the following: polyesters containing OH groups (e.g., Crylcoat 2839, Cytec) or containing acid groups (e.g., Uralac P 5000, DSM). Other examples include radiation-curable amorphous resins, e.g., VESTAGON EP-UV 100 or VESTAGON EP-UV 300, Degussa AG. Resins of this kind containing acrylate groups are also described in EP 1 323 758, for example.

As component B) use is made of (semi)crystalline polymers having a melting point of from 50 to 150° C. and containing reactive groups. These polymers may be polyesters, polyamines, polyamides, polycaprolactones, polyethers, polyurethanes, polyacrylates or mixtures or copolymers of the said polymers. Suitable reactive groups include free or blocked polyisocyanates, uretdiones, alcohols, amines, acids, hydroxyalkylamides, epoxides, oxazolines, carbodiimides, double bonds, CH-acidic groups, vinyl ethers, acrylates and/or methacrylates. Examples which can be used include the following: polyesters containing OH groups (e.g., Dynacoll 7330, Degussa AG) or containing acid groups (e.g., Dynacoll 8390, Degussa AG). Other examples include radiation-curable (acrylate group-containing) crystalline resins, e.g., VESTAGON EP-UV 500, Degussa AG. Resins of this kind containing acrylate groups are also described in EP 1 323 758, for example.

Suitable components C) include, in particular, typical powder coating hardeners, i.e., components containing reactive groups, examples being free or blocked isocyanates, uretdiones, epoxides, hydroxyalkylamides, oxazolines, carbodiimides, CH-acidic groups or the like. Typical representatives are VESTAGON B 1530 (blocked isocyanates), VESTAGON BF 1320 (uretdiones, Degussa AG), Araldit PT 910 (epoxides, Huntsman), or else VESTAGON HA 320 (hydroxyalkylamides, Degussa AG), which are also present with preference.

Auxiliaries and adjuvants D) used may be, for example, catalysts, pigments, fillers, dyes, flow control agents, such as silicone oil and liquid acrylate resins, light stabilizers, heat stabilizers, antioxidants, gloss enhancers or effect additives.

Components A), B), C) where used and/or D) where used are homogenized in the melt. This can be done in suitable apparatus, such as in heatable kneading apparatus but preferably by extrusion, in the course of which temperature limits of 130 to 140° C. should not be exceeded. Following homogenization in the melt, the homogenized composition is stored (heat-treated) for a certain time at more than 40° C. and less than the melting temperature of the crystalline component B). The preferred temperature corresponds to the arithmetic mean of the melting temperature of B) and 40° C. Thus if component B) had a melting temperature of 80° C. then 60° C. would be the preferred storage temperature. The storage time is from 2 hours to 3 days, preferably from 1 day to 2 days. After cooling to room temperature and after appropriate combination, the homogenized and heat-treated composition is ground to give the spraying-ready powder coating composition.

The components are reacted (crosslinked) thermally or by means of radiation, either with themselves and/or with one another.

The invention further provides for the use of the powder coating compositions of the invention for producing powder coatings on metal, plastics, glass, wood or leather substrates or other heat-resistant substrates.

The application of the spraying-ready powder coating composition to suitable substrates can take place by the known methods, such as by electrostatic powder spraying or fluidized-bed sintering, with or without electrostatic assistance. Following application of the powder the coated workpieces are cured conventionally by heating in an oven at a temperature of from 120 to 250° C. for from 60 minutes to 30 seconds, preferably at from 170 to 240° C. for from 30 minutes to 1 minute.

The subject matter of the invention is elucidated below with reference to examples.

### EXAMPLES

Ingredients

| | |
|---|---|
| VESTAGON EP-UV 300 | Degussa AG, amorphous urethane acrylate, |
| | Tg: approximately 45° C. |
| VESTAGON EP-UV 500 | Degussa AG, semicrystalline urethane |
| | acrylate, melting point: 77° C. |
| IRGACURE 2959 | Ciba, photoinitiator |
| IRGACURE 819 | Ciba, photoinitiator |
| KRONOS 2160 | Kronos, titanium dioxide |
| RESIFLOW PV 88 | Worlee, flow control agent |
| Worlée Add 900 | Worlee, devolatilizer |

### Powder Coating Composition (General Production Procedure)

The comminuted products are intimately mixed together with the white pigment in an edge runner mill and the mixture is then homogenized in an extruder at up to 130° C. maximum. The melt is cooled to approximately 60° C., and solidifies. This temperature is maintained, in accordance with the invention, for 48 hours. After it has cooled, the extrudate is fractionated and ground to a particle size <100 μm using a pinned-disc mill. The powder thus produced is applied to degreased, iron-phosphated steel panels using an electrostatic powder spraying unit at 60 kV, and the coated panels are baked in an oven.

### Powder Coating Composition 1

### Inventive Example 1 and Comparative Example 2

The formulations contained 60% by weight of VESTAGON EP-UV 300, 15% by weight of VESTAGON EP-UV 500, 1% by weight of Irgacure 2959, 2% by weight of Irgacure 819, 1% by weight of Resiflow PV, 1.0% by weight of Worlee Add 900, and 20% of Kronos 2160. In the first case (inventive example 1) the extrudate was held at 60° C. for 48 hours. In the second case (comparative example 2) there was no such storage at elevated temperature. The storage stability was determined in each case after 1 day, after 3 days, after 14 days, and after 28 days at 40° C. Visual assessment of the powders was made using a scale from 1 to 6, where 1 denotes complete freedom of flow and 6 denotes complete blocking. Powders rated 4 can still be applied by spraying. At a rating of 5 or more, a powder is considered to be no longer sprayable.

Assessment of storage stability after × days at 35° C.

| Days | 1 | 3 | 14 | 28 |
|---|---|---|---|---|
| Example 1 | 2.5 | 3.5 | 4 | 4 |
| Example 2* | 4 | 4.5 | 5 | 6 |

*noninventive, comparative example

It is clearly apparent that right from the start the comparative example has a poorer storage stability and after 14 days can no longer be sprayed. In contrast, the powder coating composition of the invention can still be sprayed even after 28 days.

1. A storage-stable reactive powder coating composition
substantially containing
A) from 10% to 95% by weight of at least one amorphous component containing at least one reactive group
and
B) from 5% to 50% by weight of at least one (semi)crystalline component containing at least one reactive group,
C) if desired, from 3% to 30% by weight of at least one powder coating hardener,
D) if desired, auxiliaries and adjuvants,
the powder coating composition being obtained by homogenizing components A) and B) and, where used, C) and/or D) in the melt and then storing (heat-treating) the composition for a certain time at more than 40° C. and less than the melting temperature of the (semi)crystalline component B).

2. A powder coating composition according to claim 1,
characterized in that
the homogenization takes place at from 130 to 140° C.

3. A powder coating composition according to claim 1,
characterized in that
the storage (heat-treatment) time is from 2 hours to 3 days.

4. A powder coating composition according to claim 1,
characterized in that
the storage (heat-treatment) time is from 1 day to 2 days.

5. A powder coating composition according to claim 1,
characterized in that
polyesters, polyamines, polyamides, polycaprolactones, polyethers, polyurethanes, polyacrylates or mixtures or copolymers of the said polymers are contained as component A).

6. A powder coating composition according to claim 1,
characterized in that
polyesters containing OH groups and/or acid groups are contained as component A).

7. A powder coating composition according to claim 1,
characterized in that
radiation-curable amorphous resins containing acrylate groups are contained as component A).

8. A powder coating composition according to claim 1,
characterized in that
component A) contains free or blocked polyisocyanate, uretdione, alcohol, amine, acid, hydroxyalkylamide, epoxide, oxazoline and/or carbodiimide groups, double bonds, CH-acidic groups, vinyl ether, acrylate and/or methacrylate groups as reactive groups.

9. A powder coating composition according to claim 1,
characterized in that
polyesters, polyamines, polyamides, polycaprolactones, polyethers, polyurethanes, polyacrylates or mixtures or copolymers of the said polymers are contained as component B).

10. A powder coating composition according to claim 1,
characterized in that
polyesters containing OH groups and/or acid groups are contained as component B).

11. A powder coating composition according to claim 1,
characterized in that
radiation-curable (semi)crystalline resins, are contained.

12. A powder coating composition according to claim 1,
characterized in that
component B) contains free or blocked polyisocyanate, uretdione, alcohol, amine, acid, hydroxyalkylamide, epoxide, oxazoline and/or carbodiimide groups, double bonds, CH-acidic groups, vinyl ether, acrylate and/or methacrylate groups as reactive groups.

13. A powder coating composition according to claim 1,
characterized in that
the powder coating hardener C) contains free or blocked isocyanate, uretdione, epoxide, hydroxyalkylamide, oxazoline, carbodiimide and/or CH-acidic groups as reactive groups.

14. A powder coating composition according to claim 1,
characterized in that
blocked isocyanates, uretdione, epoxides and/or hydroxyalkylamides are contained as powder coating hardeners C).

15. A powder coating composition according to claim 1,
characterized in that
catalysts, pigments, fillers, dyes, flow control agents, light stabilizers, heat stabilizers, antioxidants, gloss enhancers and/or effect additives are used as auxiliaries and adjuvants D).

16. A process for producing a storage-stable reactive powder coating composition
substantially containing
A) from 10% to 95% by weight of at least one amorphous component containing at least one reactive group
and
B) from 5% to 50% by weight of at least one (semi)crystalline component containing at least one reactive group,
C) if desired, from 3% to 30% by weight of at least one powder coating hardener,
D) if desired, auxiliaries and adjuvants,
the powder coating composition being obtained by homogenizing components A) and B) and, where used, C) and/or D) in the melt and then storing the composition for a certain time at more than 40° C. and less than the melting temperature of the (semi)crystalline component B).

17. A process according to claim 16,
characterized in that
compounds as set forth in claim 15 are contained.

18. The method of using a storage-stable reactive powder coating composition according to claim 1 for producing a powder coating on a metal, plastics, glass, wood or leather substrate or other heat-resistant substrate.
